(19) United States
(12) Patent Application Publication
(10) Pub. No.: US 2006/0162475 A1
(43) Pub. Date: Jul. 27, 2006

(54) Drive means for motor vehicles

(76) Inventors: Anders Eriksson, Goteborg (SE); Marcus Steen, Angered (SE)

Correspondence Address: YOUNG & THOMPSON, 745 SOUTH 23RD STREET, 2ND FLOOR, ARLINGTON, VA, 22202, US

(21) Appl. No.: 10/518,078

(22) PCT Filed: Jun. 17, 2003
(86) PCT No.: PCT/SE03/01018

§ 371 Date: Jul. 25, 2005

(30) Foreign Application Priority Data
Jun. 17, 2002 (SE) 0201878-6

(51) Int. Cl. F16H 61/00

(52) U.S. Cl. 74/335

(57) ABSTRACT

Drive means for motor vehicles, comprising an internal combustion engine (1) and an unsynchronised autoshift gearbox (9). The clutch and the gearbox are s controlled by an electronic transmission control unit (45) which communicates with an engine control unit (48), to which are fed signals representing the selected gear from a gear selector (46) and signals representing various engine and vehicle data. The input shaft of the gearbox is coordinated with a torque sensor (60), which provides a signal dependent of the torque on the input shaft to to the transmission control unit, which is disposed to continuously register the current torque on the input shaft and utilize the torque signal from the torque sensor to calculate the current vehicle motion resistance. The gear selection is made here based on the calculated vehicle motion resistance.

The present invention relates to a drive means for motor vehicles, comprising an internal combustion engine and an automated shift gearbox, which has an input shaft drivingly joined to the engine crankshaft and which is controlled by a control means, connected to a gear selector, and having a transmission control function and an engine control function, and to which are fed signals representing the selected gear and various engine and vehicle data, which comprise at least engine speed, rotational speed of the transmission input shaft and vehicle speed.

In today's automated shifting systems, information on vehicle motion resistance, including rolling resistance, air resistance and road incline, to select the gear in the best manner. It is therefore important that the estimation of vehicle motion resistance be as exact as possible. One method of estimating vehicle motion resistance is to compare the engine torque, which is the torque corresponding to the current injected amount of fuel, with vehicle acceleration and mass (the resisting force=the driving force to the drive wheels−vehicle mass×vehicle acceleration). This method involves however a number of uncertain factors. If, for example, an auxiliary unit, such as a cooling fan, an air compressor or an AC compressor, is engaged it will mean that the torque signal cannot be used directly for estimating the vehicle motion resistance without compensating for the torque to the auxiliary units. If one or more auxiliary units are engaged, the current injected amount of fuel will indicate a greater vehicle motion resistance that what is actually the case. Furthermore fuel quality, engine wear and variations between individual engines will also affect the result.

The purpose of the present invention is to achieve a drive unit for motor vehicles of the type described by way of introduction, which provides a more reliable estimate of the actual vehicle motion resistance to thereby make possible improved gear selection.

This is achieved according to the invention by virtue of the fact that that the input shaft of the gearbox is coordinated with a torque sensor, which provides a signal dependent on the torque on said input shaft to said control means, and that the control means are arranged to continuously register the current torque on the input shaft, to utilize the torque signal from the torque sensor for calculating the current vehicle motion resistance and selecting a gear on the basis of the calculated vehicle motion resistance.

Through the invention, the actual resistance to vehicle motion is utilized when selecting a gear, eliminating the effect of any engaged auxililiary units, fuel quality or engine wear.

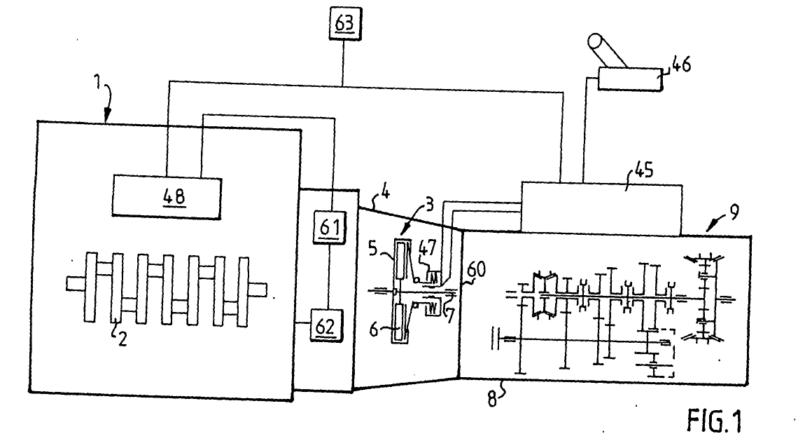

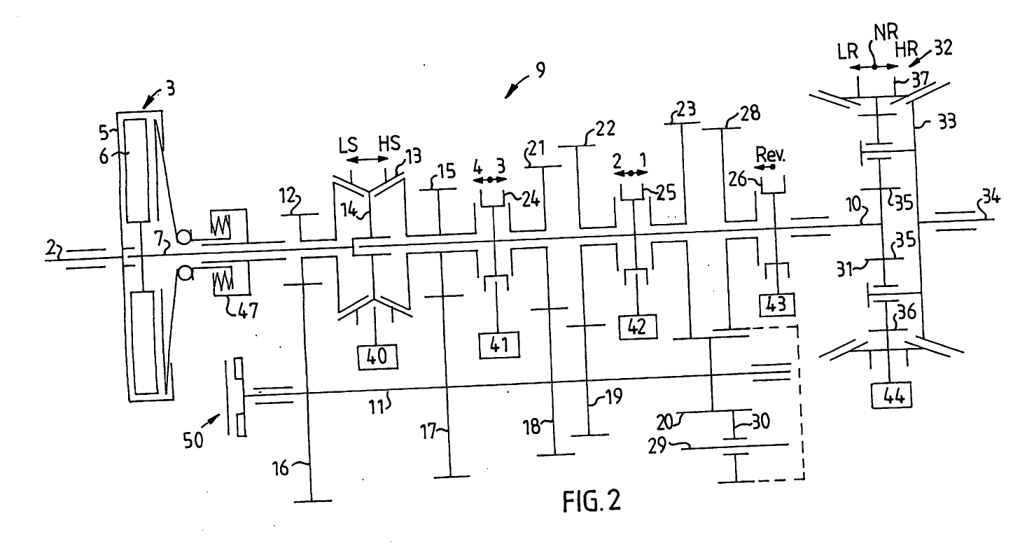

The invention will be described in more detail with reference to examples shown in the accompanying drawings, where FIG. 1 shows a schematic representation of a drive unit according to the invention and FIG. 2 shows the clutch and the gearbox of FIG. 1 on a larger scale.

In FIG. 1, 1 designates a six-cylinder internal combustion engine, e.g. a diesel engine, the crankshaft 2 of which is coupled to a single-disc dry-disc clutch, gene-rally designated 3, which is enclosed in a clutch bell 4. Instead of a single disc clutch, a dual disc clutch canbe used. The crankshaft 2 is solidly joined to the clutch housing 5, while its disc 6 is solidly joined to an input shaft 7 (FIG. 2) which is rotatably mounted in the housing 8 of a gearbox, generally designated 9. A main shaft 10 (FIG. 2) and an intermediate shaft 11 (FIG. 2) are rotatably mounted in the housing 8.

As is most clearly evident from FIG. 2, a gear 12 is rotatably mounted on the input shaft 7 and can be locked to such shaft with the aid of an engaging sleeve 13 provided with synchronizing means. Said engaging sleeve 13 is non-rotatably but axially displaceably mounted on a hub 14 non-rotatably connected to the input shaft. With the aid of the engaging sleeve 13, a gear 15, rotatably mounted on the main shaft 10, is lockable relative to the input shaft 7. The gears 12 and 15, respectively, engage gears 16 and 17, respectively, which are non-rotatably joined to the intermediate shaft 11. Additional gears 18, 19 and 20, respectively, are non-rotatably joined to the intermediate shaft 11 and engage gears 21, 22 and 23, respectively, on the main shaft 10 and lockable to the main shaft with the aid of engaging sleeves 24 and 25, respectively, which in the example shown do not have synchronizing means. On the main shaft 10, an additional gear 28 is rotatably mounted and engages an intermediate gear 30 rotatably mounted on a separate shaft 29. The intermediate gear 30 engages in turn an intermediate shaft gear 20. The gear 28 is lockable to its shaft with the aid of an engaging sleeve 26.

The gear pairs 12, 16 and 15, 17 and the engaging sleeve 13 form a splitter group with a low stage LS and a high stage HS. The gear pair 15, 17 together with the gear pairs 21, 18, 22, 19,23,20 and 28, 30 form a main group with four speeds forward and one reverse. At the output end of the main shaft 10, a gear 31 is non-rotatably mounted to form the sun gear in a two-range group of planetary type, generally designated 32, the planet carrier 33 of which is non-rotatably mounted to a shaft 34, forming the output shaft of the gearbox. The planet gears 35 of the range group 32 engage a ring gear 36 which, with the aid of an engaging sleeve 37, can be locked relative to the gearbox housing 8 for low range LR and relative to the planet carrier 33 for high range HR The engaging sleeve 37 also has a neutral position NR lying between low range LR and high range HR, in which neutral position the output shaft 34 is released from the main shaft 10.

The engaging sleeves 13, 24, 25, 26 and 37 are displaceable as indicated by the arrows in FIG. 2, providing the gear positions indicated above the arrows. Displacement is achieved by servo means 40, 41, 42, 43 and 44, schematically indicated in FIG. 2, which can be pneumatically operated piston-cylinder devices of the type used in a gearbox of the above described type, which is marketed under the name Geartronic®. The servo means are controlled by an electronic control unit 45 (FIG. 1), comprising a microcomputer depending on signals fed into the control unit representing various engine and vehicle data, including at least engine speed, vehicle speed, clutch and accelerator pedal position and, where applicable, engine brake on-off, when an electronic gear selector 46 coupled to the control unit 45 is in its automatic position. When the selector is in its position for manual shifting, the shifting occurs at the command of the driver via the gear selector 46. The control unit 45 also controls the fuel injection, i.e. the engine speed, depending on the accelerator pedal position and the air supply to a pneumatic piston-cylinder device 47, by means of which the clutch 3 is engaged and disengaged.

The transmission control unit 45 is programmed in a known manner so that the clutch 3 is held engaged when the vehicle is standing still and the gear selector 46 is in the neutral position. This means that the engine is driving the input shaft 7 and thus also the intermediate shaft 11, while the output shaft 34 is disengaged. Supplementary apparatus driven by the intermediate shaft, e.g. an oil pump for lubricating the gearbox, is driven in this position. The control unit 45 is also programmed, when the vehicle is standing still and the gear selector is moved from the neutral position to a gear engaging position, either to a position for automated shifting or to a position with a driver selected starting off gear, to first release the clutch 3 and then brake the intermediate shaft 11 to stop with the aid of the intermediate shaft brake 50 indicated in FIG. 2, and which can be a braking device of a type known per se and controlled by the control unit 45. With the intermediate shaft 11 braked to stop or at least nearly to stop, the control unit 45 now initiates shifting in the main group a starting off gear which provides the total gear ratio selected by the automated transmission or by the driver. When the driver, after engagement of the selected starting-off gear, e.g. first gear, depresses the accelerator, the accelerator pedal will function as a reversed clutch pedal, which, via the transmission control unit successively increases the clutch engagement with increasing throttle opening.

When shifting—initiated either directly by the driver or by automatic control means in accordance with a gear selection strategy stored in the transmission control unit 45, which can take into account hw the vehicle surroundings will appear in the immediate future, the transmission control unit 45 first controls the engine control unit 48 to regulate the fuel supply to the engine, so that a torqueless or practically torqueless state is created in the vehicle drive chain. In other words, the torque transmission from the engine crankshaft 2 to the input shaft 7 of the gearbox 9 must be zero or at least practically zero. The transmission control unit 45 receives continuous information on, and registers the current engine torque via, the amount of fuel injected.

The transmission unit 45 also receives continuous information on current torque on the gearbox input shaft 7 via a torque sensor 60 coupled to the input shaft. The sensor can be of a type known per se and used in laboratory contexts The sensor utilizes the signal from the torque sensor 60 to compute the current vehicle resistance. The transmission control unit 45 thus determines the gear and the moment of engagement based on the actual resistance to vehicle motion and not on the basis of the engine load, which is affected by the load from one or more engaged auxiliary units. 61 designates generally one or more auxiliary units, which are driven from one or more engine driven/engine mounted power take-offs 62 before the clutch 3. The auxiliary units 61, for example a hydraulic pump, a cooling fan, a generator, an air compressor or an AC compressor, can be engaged to be driven by the engine or can be disengaged by manual and/or automatic controls 63 coupled to the engine control unit 48.

The invention has been described above with reference to a stepped unsynchronised autoshift gearbox, but the principle of using a torque sensor on the input shaft of an automated shift transmission and using the torque signal from the torque sensor to calculate the vehicle motion resistance and select the gear, is of course not limited to this type of automatic transmission, but can be used on other types of automated transmissions, such as those using torque converters and planet gearing steps.

1. Drive unit for motor vehicles, comprising an internal combustion engine (1) and an automated shift gearbox, which has an input shaft drivingly joined to the engine crankshaft and which is controlled by a control means (45, 48), connected to a gear selector (46), and having a transmission control function and an engine control function, and to which are fed signals representing the selected gear and various engine and vehicle data, which comprise at least engine speed, rotational speed of the transmission input shaft and vehicle speed, characterized in that the input shaft (7) of the gearbox is coordinated with a torque sensor (60), which provides a signal dependent on the torque on said input shaft to said control meanss, and that the control means (45,48) are arranged to continuously register the current torque on the input shaft, to utilize the torque signal from the torque sensor for calculating the current vehicle motion resistance and selecting a gear on the basis of the calculated vehicle motion resistance.

2. Drive means according to claim 1, characterized in that the gearbox is a step gearbox and has an input shaft (7) connected via a disc clutch (3) to the engine crankshaft, said step gearbox (9) having at least one intermediate shaft (1 ). mounted in a housing, said intermediate shaft (11) having at least one gear (16, 17) in engagement with a gear (12, 15) on the input shaft, a main shaft (10) which is mounted in the housing and has gears (15, 21, 22, 23) engaging gears (17, 18, 19, 20) on the intermediate shaft, at least one gear in each pair of interengaging gears on the intermediate shaft and the main shaft being rotatably mounted on its shaft and lockable by engaging means (13, 24, 25) of which at least some forward gears lack a synchronization function.
